(19) United States
(12) Patent Application Publication
(10) Pub. No.: US 2015/0378102 A1
(43) Pub. Date: Dec. 31, 2015

(54) FEEDBACK SYSTEM FOR IMPROVING THE STABILITY OF A CO2 LASER BASED SPLICING AND TAPERING APPARATUS

(71) Applicant: AFL Telecommunications LLC, Duncan, SC (US)

(72) Inventors: Hiroshi SUGAWARA, Greenville, SC (US); Wenxin ZHENG, Moore, SC (US)

(73) Assignee: AFL Telecommunications LLC, Duncan, SC (US)

(21) Appl. No.: 14/411,212

(22) PCT Filed: Jun. 27, 2013
(86) PCT No.: PCT/US13/48187

§ 371 Date: Dec. 24, 2014

Related U.S. Application Data
(60) Provisional application No. 61/664,969, filed on Jun. 27, 2012.
(60) Provisional application No. 61/664,983, filed on Jun. 27, 2012.

(51) Int. Cl. G02B 6/255

(52) U.S. Cl. CPC G02B 6/2551; G02B 6/2553; G02B 6/2552

(57) ABSTRACT

An apparatus for splicing and tapering optical fibers employing a feedback system for stabilizing the laser output is disclosed. The apparatus may include a laser illuminating a target-area of one or more optical fibers by a laser beam; one or more cameras receiving light from one or more areas of the fibers and forming images of the one or more areas; a beam sampler detector sampling the beam power; and a controller receiving images from the camera and a signal from the power sampler. The controller may use the images received from the camera and the signal received from the detector as feedback parameters and to control the laser output according to said signal and said images such as to stabilize the laser output. The controller may include an image analysis unit determining, based on the images, a brightness or temperature distribution over the areas of the fibers.

### CROSS-REFERENCE TO RELATED APPLICATIONS

This application is based upon and claims the benefit of priority from U.S. Provisional Application No. 61/664,969, filed Jun. 27, 2012, and Provisional Application No. 61/664,983, filed Jun. 27, 2012 in the United States Patent and Trademark Office, the disclosures of which are incorporated herein in its entirety by reference.

### BACKGROUND

1. Field

The invention relates to an apparatus, system and method for splicing, tapering, and processing optical fibers.

2. Related Art and Background

Splicing and tapering optical fibers are necessary and often performed procedures in the development and maintenance of optical fiber networks, systems and devices.

Splicing of two optical fibers refers to joining the two fibers together end to end. Splicing may be performed mechanically or by fusion. Fusion splicing refers to fusing or welding, by using a heat source, two fibers together. Fusion splicing is the most widely used method of splicing because it provides low loss, low reflectance, and strong and reliable joint between two fibers. FIG. 1 shows a schematic diagram of splicing two fibers la and lb.

Tapering of an optical fiber refers to a process of reducing the diameter of a fiber over a certain region or length. Tapering may be performed by heating the fiber and applying a tensile force to stretch and thin the fiber. Such a method may taper the core and cladding evenly and at the same time which results in a taper that changes only the fiber diameter. FIG. 2 shows a schematic diagram of tapering a fiber.

Several types of fusion splicing have been developed, such as: heating the ends of the fibers to be joined with a flame torch, heating the fibers by an electrode arc discharge, heating the fibers by a filament heater, and heating the fibers by a CO₂ laser. The above methods may also be used to perform tapering. Among these methods, the one using a CO₂ laser has the advantage of being the cleanest and not causing deposits on the fibers.

The CO₂ laser can be used as heat source to heat fibers, ensuring repeatable performance and low maintenance and eliminating electrode or filament maintenance and instability. CO₂ laser heating also eliminates any deposits on the fiber surface that might occur from use of filaments or electrodes. The very clean and deposit-free fiber surface ensures reliable operation of very high power fiber lasers or power delivery systems.

Typical CO₂ lasers have an output power fluctuation of +/−5%. This produces inconsistent splicing results and may cause irregularities and ripple in a taper profile.

It is an object of the invention to provide an apparatus and a method for stabilizing the CO₂ laser power during fiber splicing such as to minimize output power and fiber brightness fluctuations, thereby providing an improved method of splicing.

It is also an object of the invention to provide an apparatus and a method for stabilizing the CO₂ laser power during fiber tapering such as to minimize output power and fiber brightness fluctuations, thereby providing an improved method of tapering fibers.

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

The foregoing general description and the following detailed description are only exemplary and explanatory and they are intended to provide further explanation of the invention as claimed.

### SUMMARY

Additional features of the invention will be set forth in the description which follows, and in part will be apparent from the description, or may be learned by practice of the invention.

One embodiment of the invention discloses an apparatus for splicing and tapering optical fibers. The apparatus may include a laser configured to illuminate a target-area of one or more optical fibers by a laser beam; one or more cameras configured to receive light from one or more areas of the fibers and form images of the one or more areas; a beam sampler detector configured to sample the beam power; and a controller configured to receive images from the camera and to receive a signal from the power sampler. The controller may be configured to use the images received from the camera and the signal received from the detector as feedback parameters and to control the laser output according to said signal and said images such as to stabilize the laser output and the brightness of the fiber.

In other embodiments the invention the controller may include an image analysis unit configured to determine, based on the received images, a brightness distribution or a temperature distribution over one or more areas of the fibers.

In another embodiment is disclosed a method for splicing, tapering and heat processing optical fibers. The method may include the following: shining a beam of a laser on a target-area of one or more optical fibers; receiving light from one or more areas of the fibers by one or more cameras; forming images of the one or more areas; sampling the laser beam by a beam sampler in conjunction with a detector; and controlling the laser output, according to a signal received from the beam sampler and to said images received from the cameras, such as to stabilize the laser output and the brightness of the fiber.

In other embodiments the method may include determining a brightness distribution or a temperature distribution over one or more areas of the fibers according to the formed images.

It is to be understood that both the foregoing general description and the following detailed description are exemplary and explanatory and are intended to provide further explanation of the invention as claimed.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 shows a schematic diagram of splicing two optical fibers according to an exemplary embodiment of the present invention.

FIG. 2 shows a schematic diagram of tapering an optical fiber according to an exemplary embodiment of the present invention.

FIG. 3 shows a schematic diagram of an apparatus for splicing and tapering optical fibers according to an exemplary embodiment of the present invention.

FIG. 4 shows another schematic diagram of the apparatus at FIG. 3 when the apparatus is used for splicing two fibers according to an exemplary embodiment of the present invention.

FIG. 5 shows another schematic diagram of the apparatus at FIG. 3 when the apparatus is used for tapering fibers according to an exemplary embodiment of the present invention.

FIG. 6 shows a flowchart of a method for splicing or tapering fibers according to an exemplary embodiment of the present invention.

FIG. 7 shows a fiber that has been tapered by a splicing and tapering apparatus according to an exemplary embodiment of the present invention.

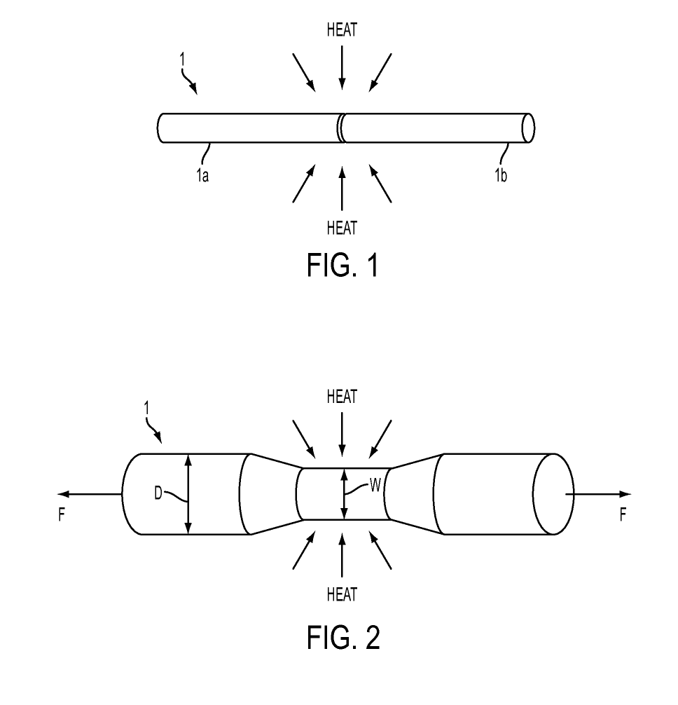

### DETAILED DESCRIPTION

The following detailed description is provided to gain a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Throughout the drawings and the detailed description, unless otherwise described, the same drawing reference numerals are understood to refer to the same elements, features, and structures. The relative size and depiction of these elements may be exaggerated for clarity.

Further, it will be understood that when an element is referred to as being “connected to” another element, it can be directly connected to the other element, or intervening elements may be present. The terminology used herein is for the purpose of describing particular embodiments only and is not intended to be limiting of the present disclosure.

Although some features may be described with respect to individual exemplary embodiments, aspects need not be limited thereto such that features from one or more exemplary embodiments may be combinable with other features from one or more exemplary embodiments.

Hereinafter, an exemplary embodiment will be described with reference to accompanying drawings.

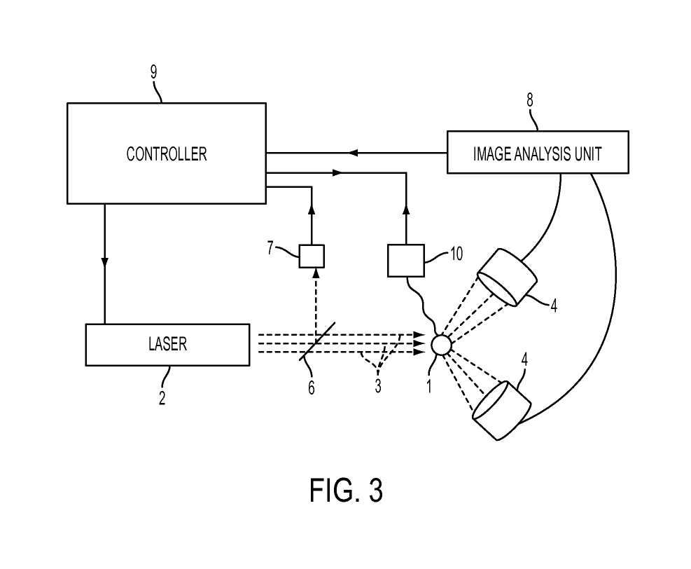

FIG. 3 shows a first schematic diagram of an apparatus for splicing and tapering optical fibers according to a first exemplary embodiment of the invention. The apparatus may include a CO₂ laser 2 shining a laser beam 3 on the fibers 1; one or more cameras 4; a beam sampler 6; a light detector 7; an image analysis unit 8; a controller 9; and a fiber positioning/strain control unit 10.

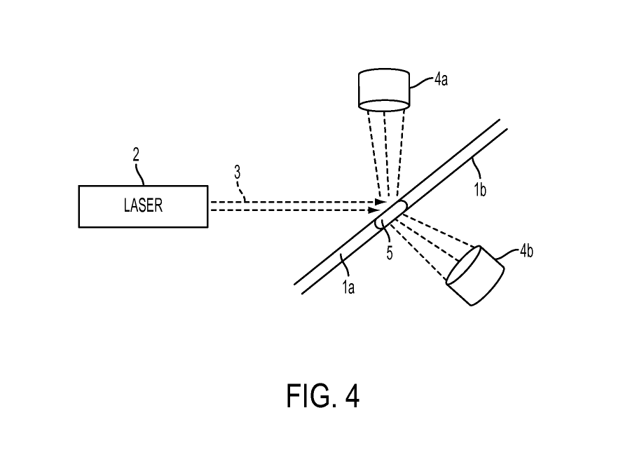

FIG. 4 shows another schematic diagram of the exemplary embodiment of the invention when the apparatus is used for splicing two fibers.

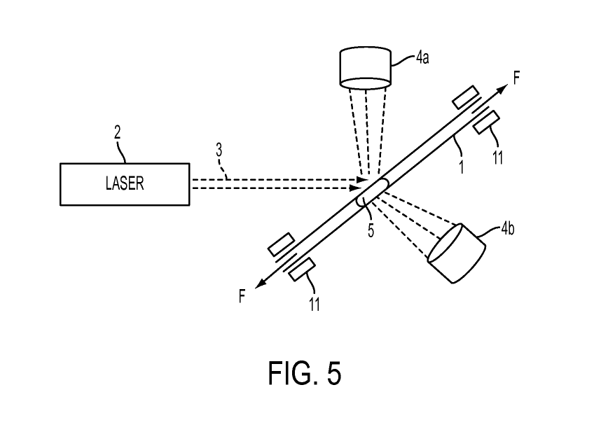

The specific embodiments described in this application disclose an apparatus which may be used to perform both splicing and tapering of fibers. FIG. 5 shows another schematic diagram of the exemplary embodiment of the invention when the apparatus is used for tapering fibers.

In the following a process of performing splicing of two fibers, according to an exemplary embodiment of the invention, is described with reference to FIGS. 3 and 4. A process of performing tapering of a fiber is described in parallel with splicing and is described with reference to FIGS. 3 and 5.

In the case the apparatus is used for splicing, the two fibers to be spliced 1a and 1b are placed end to end in the apparatus. The distance between the two fibers may be adjusted by a fiber positioning unit such as to ensure an end to end fiber distance proper for splicing the two fibers. The fibers may have a diameter between 20 micron and 3000 micron. The fibers may be made out of various materials, such as Silica based glass, Fluoride glass, Chalcogenide glass, Zblan glass, etc.

The CO₂ laser 2 may shine a laser beam 3 on a target area T1 of the two fibers. The target area T1 may cover both an end of the first fiber 1a and an end of the second fiber 1b. The laser beam may heat the ends of the fibers to such temperatures and for such a length of time as to weld the two fiber ends together. The laser beam may cause partial melting and other physical and chemical changes of the fiber material. By controlling the temperature distribution of the fibers and the length of time the fibers are heated, the two fibers may be spliced into a single fiber having good properties, such as low splice loss and good splice strength.

The CO₂ laser power may be from about 0.5 W to about 100 W. The laser spot size at the level of the fibers may be from about 0.5 mm to 10 mm However, aspects of the invention are not limited by the type of laser used, by the laser power or by the spot size. For example, other types of laser, different from CO₂ laser and other combinations of laser powers and spot sizes may be used.

In the case the apparatus is used for tapering, the fiber to be tapered 1 is placed in the apparatus as shown in FIG. 5. Forces may be applied to the fiber and the position of the fiber may be adjusted by a motion and force application unit 11. The CO₂ laser 2 may shine a laser beam 3 on a target area of the fiber. By controlling the temperature distribution over the fiber and the length of time the fiber is heated, the fiber may be properly tapered.

The laser power of the laser may fluctuate in time thereby causing a decrease in the quality of the splicing or the tapering. For instance, the CO₂ laser power may fluctuate by about 5% over a period of time which varies from a couple seconds to a couple minutes. The laser power may be stabilized, by using feedback parameters as described below, thereby obtaining good quality splicing and tapering of fibers.

Moreover the laser beam incident on the fibers may have a shape and direction that may change during the splicing tapering and heat processing and that is not completely controllable and known. For example, during a first period the beam profile may have a first shape/profile, may fall on the fibers in a first way, and consequently only a certain percentage of the beam (i.e. a first percentage) may be absorbed by the fibers. During a second period the laser beam may have a second shape/profile different from the first, may fall on the fibers in a different way, and consequently the fibers may absorb a second percentage of the laser beam which is different from the first percentage. Such a change in beam shape and beam direction, during the splicing tapering and heat processing, may give rise to fluctuations and variations of fiber brightness and heating. By using feedback control described below, the variations in beam shape and directions described above may be reduced or canceled out thereby stabilizing the brightness of the fibers and the heating of the fibers. This way good quality splicing and tapering of fibers may be provided.

The output of the laser beam may be adjusted such as to obtain a desired splicing and/or tapering. The laser power may be increased such as to deliver more heat to the fibers. Conversely, the laser power may be decreased such as to deliver less heat to the fibers. The laser wavelength is such that the fiber material absorbs part of the incident laser light. Part of the absorbed laser light is transformed into heat. Preferably, the laser wavelength and fiber material are such that a high percentage of the laser light incident on the fibers is absorbed and a high percentage of the absorbed light is transformed into heat. If needed, the laser output may be further adjusted such as to change the focus of the laser beam or to change the direction of the laser beam.

The beam sampler 6 may sample the laser beam 3 by redirecting part of the laser beam 3 on the detector 7. Preferably, the beam sampler redirects only a small percentage of the laser beam 3 (i.e. high transmission efficiency) on the detector. The detector 7 may measure the power of the light incident on the detector. The beam sampler may have a predetermined transmission efficiency. The power measured by the detector and the transmission efficiency of the beam sampler may be used in determining the total beam power.

The one or more cameras 4 may be disposed such as to image one or more areas of the fiber. The cameras may comprise a plurality of light detecting elements or pixels arranged in an array. Each of the camera may have a certain spectral response. In an exemplary embodiment, a first camera 4a is disposed at a first position and a second camera 4b is disposed at a second position. The first camera 4a may be disposed such as to collect light/radiation from a first area A1 of the fibers and the second 4b may be disposed such as to collect light from a second area A2 of the fibers. The cameras may form images according to the collected light.

The laser light incident on the fibers is partially scattered and reflected by the fibers. Further, the laser light incident on the fibers causes the fibers to become hot and emit thermal radiation. The light incident on the light detecting elements of the first and second cameras may include both thermal radiation and laser light scattered or reflected by the fibers or other components of the apparatus. The cameras may be set to collected light for a predetermined exposure time and form images according to the light incident on each of the pixels of the camera during the exposure time.

The cameras may have a spectral response from 400 nm to 1200 nm. The fibers may be heated to temperatures from about 100C to 2500C. The thermal radiation/light emitted by the fibers may have a wavelength primarily from about 400 nm to about 1100 nm However, aspects of the invention are not limited by the spectral response of the camera or the camera type. For example, different camera types may be used as needed. Further, aspects of the invention are not limited by the temperature to which fibers are heated and the wavelengths of light primarily emitted by the fibers. For example, fibers may be heated at different temperatures, function of their material, and may emit light in a different spectral range.

The CO₂ laser wavelength is about 10.6 micron. The laser light scattered or reflected onto the detecting elements of the cameras may be filtered out by the spectral response of the light detecting elements of the cameras. Thereby, the cameras may detect only the thermal radiation emitted by the heated fibers and not the scattered laser light. Thus, the formed images may correspond only to the thermal radiation emitted by the fibers.

The image analysis unit 8 may receive the images from the cameras and may perform a real-time analysis of the images. The image analysis unit may determine a brightness distribution for each of the imaged areas of the fibers according to a signal received from each of the pixels of the cameras. A total integrated brightness of a certain area of the fibers may be calculated. The image analysis unit may further determine a temperature distribution of the imaged areas of the fibers. The image analysis unit may perform image analysis/processing and determine one or more of the following: an image brightness distribution; a temperature distribution over the fibers; an integrated brightness over a certain area; an average temperature over a certain area; or other information that can be extracted from the images.

For splicing and tapering, the absolute temperature of the fiber may not be necessary. The melting point of different type of glass is very different. For example, Silica base glass melts at 1800° C., whereas Zblan glass may melts at 250° C. The appropriate CO₂ power level is determined by experiment for different class types. When the CO₂ power is optimized for a particular fiber type, the camera exposure time can be adjusted accordingly to get an image with desired brightness. One of the purposes of the feedback system and method disclosed is to keep the fiber to a stable fibers brightness (e.g. the fiber brightness desired by the operator) by controlling the CO₂ laser power and output. This feedback control is very important since it keeps a consistent slice loss and minimizes the taper ripple.

The image analysis unit may combine images collected from different areas of the fiber into a combined image of the combined areas. For instance, if a first camera collects a first image of an area A1 of the fibers and a second camera collects a second image of an area A2 of the fibers, then the image analysis and processing unit may combine the first image and the second image into a combined image of an area including both A1 and A2.

The controller 9 may receive, from the image analysis unit, the determined brightness distribution for each of the imaged areas. The controller may further receive the determined temperature distributions, the integrated brightness for certain areas of the fibers and other image analysis results. The controller 9 may further receive from the detector 7 a signal corresponding to a beam power of the laser beam 3. The information received by controller from the image analysis unit and from the detector may be used as feedback parameters. The feedback parameters may be, in turn, used to adjust the output of the laser such as to stabilize the brightness distribution over certain fiber areas to a desired brightness. The desired brightness distribution may be a brightness at which the fiber is properly spliced, tapered or processed. The brightness distribution may be indicative of the temperature distribution over the fiber. This way, the beam power variations of the laser, such as the 5% variations in power of the CO₂ laser, may be reduced or canceled out. By using feedback control described above, the variations in beam shape and directions described above may be reduced or canceled out thereby stabilizing the brightness of the fibers and the heating of the fibers. This way good quality splicing and tapering of fibers may be provided. The feedback control of the laser may be performed in real-time.

Based on the beam power received from detector 7 and on the information received from the image analysis unit 8 (e.g. brightness and temperature distributions over the fiber areas) the controller 9 may determine parameters of the laser beam incident on the fibers, at the time the images are collected, such as beam power, beam focus and beam direction.

Based on the signal received from detector 7 and on the information received from the image analysis unit 8 (e.g. brightness and temperature distributions over the fiber areas) the controller 9 may control the laser such as to adjust or stabilize the output of the laser to a desired state according to the feedback received from the beam. For instance, the controller may control the laser such as to stabilize the power of the output beam to a predetermined value. The feedback control described above may be performed in real-time.

The controller may control the output of the beam such as to stabilize the brightness distribution or the temperature distribution over the fibers. The brightness and temperatures distributions may be stabilized to predetermined values or distributions. For instance, a certain predetermined temperature distribution over the fiber may be known as being the proper temperature distribution for performing good quality splicing/tapering. Thus, a good quality splicing/tapering may be achieved by stabilizing the laser output such as to obtain the predetermined brightness or temperature distribution. The feedback control described above may be performed in real-time.

The feedback control may be used to stabilize various quantities such as: the beam power output; the brightness distribution of the fibers; the temperature distribution of the fibers; an integrated brightness over the fibers or a certain area of the fibers; an average temperature over an area; or other quantities a user may want to stabilize.

The above mentioned operations (e.g. collecting images, sending images from the cameras to the analysis unit, sending results of the analysis to the controller, receiving a signal from detector, using the results of the analysis and the signal from the detector to adjust the laser beam output) may be performed by electronics and hardware equipment in a short time. The analysis is performed in a fast enough time such as to allow the system to feedback information about the images to the controller in a short time, thereby efficiently stabilizing the laser power or other quantities to be stabilized.

In another exemplary embodiment of the invention, the apparatus may further include or may be interfaced to a computer system. The computer may be used to control the cameras, the image analysis unit, the detector, the laser, the motion control unit and any other component that may be part of the apparatus or may interact with the apparatus. The computer system may be used to program the controller 9 such as to automatically implement certain splicing/tapering and processing procedures. The splicing/tapering and processing procedures may be implemented as a sequence of steps. For instance, the state of the fibers (e.g. the temperature distribution of the fibers) may be changed from one state corresponding to a first temperature distribution over the fibers to another state corresponding to another temperature distribution over the fibers. The state of the fibers can be changed according to a certain predetermined sequence of states. Also, the apparatus may determine the current state of the fiber and, in response to the determined state, the computer program may adjust the laser output such as to change the current state to a different state. The state of the fiber may be determined as a depending on the images received from the cameras and/or on other feedback parameters. The feedback control may be performed in real-time.

In another exemplary embodiment, based on the state of the fiber, the computer may find whether the splicing/tapering process is complete and may terminate the splicing/ tapering by shutting off the beam.

In another exemplary embodiment, the apparatus may include a motion control unit 10 and a fiber positioning/force application unit 11. The motion control unit may be interfaced with the computer. The motion control unit may control the moving of the fibers, application of forces F on the fibers and/or stretching of the fibers in a predetermined way or according to the feedback received from the cameras and detector. The feedback control may be performed in real-time. The moving, stretching, and application of forces F may be performed simultaneously, or according to a predetermined sequence, with the changing of the beam output shined on the fibers. The fiber position unit may move the fibers from one position to another such that the laser spot moves from one area of the fibers to another area of the fibers thereby heating different areas of the fibers.

The above 8, 9, and 10 elements shown in FIG. 3 are intended as functional elements of the embodiments presented herein and no intent to create limitations regarding the physical implementation of such elements should be inferred. Elements may be combined into a single entity, may be consolidated, may be omitted and may be altered without departing from the scope and spirit of the present invention.

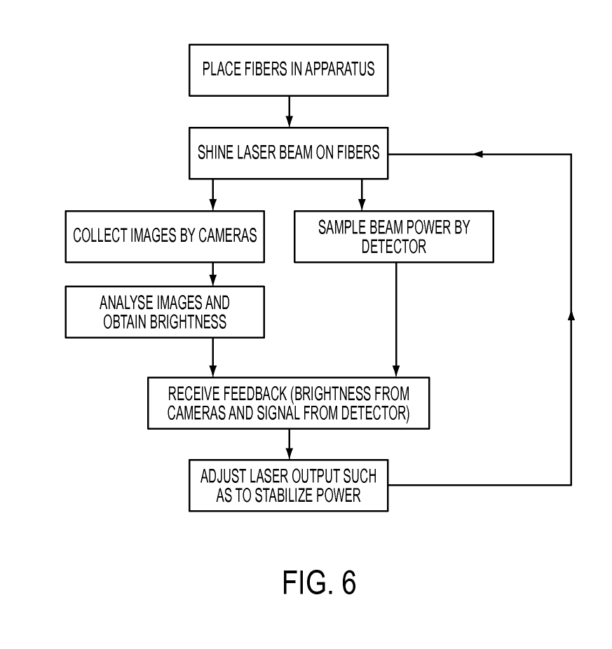

Methods for splicing, tapering and performing various heat treatments of optical fibers, according to exemplary embodiments of the invention, are described hereinafter with reference to the drawings. FIG. 6 shows a flowchart of an exemplary embodiment of a method for splicing and tapering fibers.

In the case of splicing, the two fibers to be spliced may be disposed end to end. The distance between the two fibers may be adjusted by a fiber positioning unit such as to ensure an end to end distance proper for splicing the two fibers. A laser beam of a CO₂ laser may be shined on the two fibers for a certain period of time. The laser beam may heat the ends of the two fibers to temperatures at which the fibers are welded together.

In the case of tapering, a fiber may be disposed in the tapering apparatus. A laser beam of a CO₂ laser may be shined on the fiber for a certain period of time. The laser beam may heat the fiber to temperatures at which the fiber can be tapered.

One or more cameras, disposed such as to image the splicing/tapering region, may collect one or more images of different areas of the fibers. Each of the cameras may collect images of a different area. The images collected by the camera may be received by an image analysis unit. The image analysis unit may perform image analysis/processing and determine one or more of the following: an image brightness distribution; a temperature distribution over the fibers; an integrated brightness over a certain area; an average temperature over a certain area; or other information that can be extracted from the images. The image analysis unit may combine images collected from different areas of the fiber into a combined image of the combined areas.

A controller may receive the results of the analysis from the analysis unit and a signal from the detector. The results of the analysis and the signal may be used as feedback quantities. Based on these feedback quantities, the controller may determine a set of parameters for adjusting the laser output. Then, the controller may adjust the laser output according to these parameters. Further, the controller may adjust a power of the laser output, a focus of the beam or a direction of the beam. Thereby the laser power, or other quantities to be stabilized, may be stabilized and the feedback cycle is completed.

Once a feedback cycle is completed, a new feedback cycle is started by repeating the above operations. Multiple feedback cycles or sequences of feedback cycles may be performed until the splicing or tapering is complete.

In another exemplary embodiment, the fibers may be moved and forces variable in time may be applied to parts of the fiber. The moving of the fibers, and the application of forces on the fibers and/or stretching of the fibers may be performed in a predetermined way or according to the feedback received from the cameras and the detector. The moving, stretching, and application of force may be synchronized with changing of the beam output shined on the fibers.

The above operations (e.g. collecting images, sending images from the cameras to the analysis unit, sending results of the analysis to the controller, receiving a signal from detector, using the results of the analysis and the signal from the detector to adjust the laser beam output) are preferably performed in real-time or a short time such that the total feedback cycle time is short. A short feedback time ensures good stabilization of the laser output or other quantities that may be stabilized. The cameras, the image analysis unit; the controller, and the detector may employ fast electronics such as to minimize the feedback and the cycle time. The feedback cycle time may be from about 100 milliseconds to about 300 milliseconds. However, aspects of the invention are not limited by the feedback cycle time.

The aspects of the invention in this application are not limited to the disclosed operations and sequence of operations. For instance, operations may be performed by various elements and components, may be consolidated, may be omitted, and may be altered without departing from the spirit and scope of the present invention.

A first experiment has been conducted to find whether an apparatus employing the feedback control described above is efficiently stabilizing the output power of the laser. An output power of a CO₂ laser has been recorded, over a period of about 7 minutes, for an apparatus that does not employ feedback control of the laser output. An output power of the CO₂ laser has been recorded, over the same period of time −7 minutes, for an apparatus that employs the feedback control described above. The time dependence of the two recorded output powers have been compared with each other. The variation in time of the laser power without feedback control was about +/−5% whereas the variation in time of the laser power with feedback control was significantly lower. It can be as low as +/−0.5%. The temperature of the laser unit has not been critical in this experiment and for the experimental system. Thus, the apparatus employing feedback control, as described above, significantly stabilized the output power of the CO₂ laser.

A second experiment has been conducted to find the light loss of the splices when feedback control is employed as compared with the light loss of the splices when feedback control is not employed. Twenty splices between twenty pairs of SMF28 fibers were performed with an apparatus as the one described above employing feedback control. The light loss due to the splicing was measured for each of the splices. The average loss for the twenty splices was 0.026 dB while the maximum loss was 0.05 dB. Similar measurements were conducted for 20 splices performed in the same conditions but without feedback control. The average loss for splices performed without feedback was 0.15 dB. As seen, the splices made without feedback control have about six time more loss than the ones made with feedback control. The significant higher loss of the fibers made without feedback control is due to the unstable power of the laser beam incident upon the fibers.

Further, in a third experiment, splice strength measurements were performed for the 20 splices made with feedback control. The average splice strength for the 20 splices was 263 kpsi, whereas the minimum strength was 157 kpsi. Similar splice strength measurements were performed for splices made without feedback. The splice strength of the splices made without feedback control was about the same with the splice strength of the splices made with feedback control.

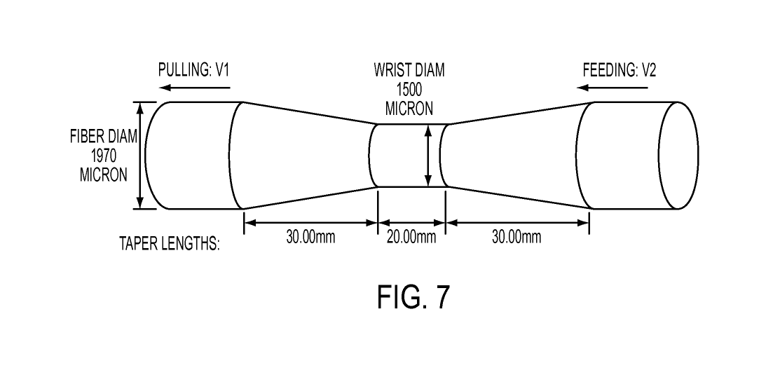

A fourth experiment has been conducted to test the quality of the tapering for a large diameter optical fiber. A fiber having a diameter of 1.97 mm has been tapered, as shown in FIG. 7, by an apparatus employing feedback control. The fiber has been tapered over a taper length of 80 mm including two side parts having lengths of 30 mm and a central part having a length of 20 mm The diameter of the central part was about 15 microns. A CO₂ laser beam of power was used for a tapering time of about 11 minutes. The maximum peak to peak taper ripple was about 10 microns and the ripple to fiber waist ratio was about 1/150 or 0.7%. As seen, the taper performed by employing feedback control has good quality.

In conclusion, the splicing/tapering apparatus and methods described above are significantly improved with respect to the apparatuses and methods of the prior art. This improvement is due, at least in part, to the fact that the disclosed apparatus employs a feedback control that uses both beam sampler feedback, performed via the sampler and the detector, and image brightness feedback performed via the one or more cameras. Beam power feedback is quick since it is based on electronics having very short response times. Fiber image brightness feedback may have a slightly slower response time because of image processing and analysis. Image brightness feedback is particularly able to keep fibers at the right temperature. This is especially important during tapering because fiber diameter varies during the tapering process and, consequently, the laser light absorption also varies along the fiber.

A CO₂ laser based fiber processing system employing the feedback system described in the above exemplary embodiments may easily splice fibers with extremely large diameter differences. For example, splicing a 2 mm diameter end-cap glass rod to a 0.125 mm diameter LMA fiber is a tremendous challenge for all conventional heating sources. In order to soften the 2 mm rod, very high power must be applied. But high power may completely melt the 0.125 mm fiber, vaporizing the fiber or creating a ball end. On the contrary, this type of splice is a relatively straightforward process when using the CO₂ heating source. The fiber heating mechanism of a CO2 laser is fundamentally different from all other heating methods such as flame, arc discharge, and filament. The silica based optical fiber is heated by its absorption of the 10.6 micron wavelength CO₂ laser energy, while all other heating methods use radiation and heat conduction. A large diameter fiber has a larger absorption surface, while a small diameter fiber has a smaller absorption surface. Thus, the power of the CO₂ laser does not need to be substantially different when splicing two fibers with different diameters.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed:

1. An apparatus for splicing and tapering optical fibers, the apparatus comprising:
a laser configured to illuminate a target-area of one or more optical fibers by a laser beam;
one or more cameras configured to receive light from one or more areas of the fibers and form images of the one or more areas;
a beam sampler detector configured to sample the beam power; and
a controller configured to receive images from the camera and to receive a signal from the power sampler;
wherein the controller is configured to use the images received from the camera and the signal received from the detector as feedback parameters and to control the laser output according to said signal and said images such as to stabilize a brightness of the fibers.

2. The apparatus of claim 1 wherein the controller is configured to control the laser output according to said signal and said images such as to stabilize the laser power.

3. The apparatus of claim 1, wherein the controller comprises an image analysis unit configured to determine, based on the received images, a brightness distribution over one or more areas of the fibers.

4. The apparatus of claim 3, wherein the image analysis unit is further configured to determine a fiber temperature distribution corresponding to each of the areas.

5. The apparatus of claim 3, wherein the controller is configured to stabilize the laser output based on:
a beam power determined via the signal received from the beam sampler; and
a brightness distribution at one or more areas of the fiber.

6. The apparatus of claim 1, wherein the controller is further configured to:
determine a state of a splicing process or a tapering process;
adjust the laser beam according to the determined state; and
shut off the laser beam upon completion of the splicing or the tapering.

7. The apparatus of claim 1, wherein the one or more camera comprises:
a first camera receiving images from a first area of the fiber; and
a second camera receiving images from a second area of the fiber different from the first area;
wherein the information received by the controller comprises both information concerning images collected by the first camera and images collected by the second camera.

8. The apparatus of claim 1, further comprising:
a fiber positioning and force application unit;
wherein the controller is configured to control the fiber movement and force application on the fiber as synchronized with controlling the laser output.

9. The apparatus of claim 1, wherein the controller is configured to control the laser output, according to said signal and said images, such as to stabilize a brightness distribution of the fibers or a temperature distribution of the fibers.

10. The apparatus of claim 3, wherein the cameras, the detector, the image analysis unit, and the controller are configured to perform operations live or in real-time.

11. A method for splicing, tapering and heat processing optical fibers, the method comprising:
shining a beam of a laser on a target-area of one or more optical fibers;
receiving light from one or more areas of the fibers by one or more cameras;
forming images of the one or more areas;
sampling the laser beam by a beam sampler in conjunction with a detector; and
controlling the laser output, according to a signal received from the beam sampler and to said images received from the cameras, such as to stabilize the laser output.

12. The method of claim 11, further comprising:
determining a brightness distribution over one or more areas of the fibers according to the formed images.

13. The method of claim 12, further comprising:
determining a fiber temperature distribution corresponding to each of the areas according to the formed images.

14. The method of claim 12, wherein the laser output is controlled according to:
a signal received from the beam sampler; and
the brightness distribution at one or more areas of the fiber.

15. The method of claim 12, wherein the brightness distribution is determined according to the light emitted by the fibers due to heat radiation of the fibers.

16. The method of claim 11, further comprising:
determining a state of the splicing process, the tapering process or the heat processing process;
adjusting the laser output according to the determined state;
determining whether the splicing, tapering or heat processing is completed.

17. The method of claim 12, wherein the one or more camera comprises:
a first camera receiving images from a first area of the fiber; and
a second camera receiving images from a second area of the fiber different from the first area;
wherein the information received by the controller comprises both information concerning images collected by the first camera and images collected by the second camera.

18. The method of claim 11, further comprising:
moving the one or more fibers in sync with controlling the laser output.

19. The method of claim 11, further comprising:
applying forces to the one or more fibers in sync with controlling the laser output.

20. The method of claim 11, further comprising:
controlling the laser output, according to a signal received from the beam sampler and on said images, such as to stabilize a brightness distribution or a temperature distribution over the one or more areas.
